(19) United States
(12) Patent Application Publication
(10) Pub. No.: US 2003/0065559 A1
(43) Pub. Date: Apr. 3, 2003

(54) Bar and restaurant services virtual private network

(76) Inventor: Thomas A. Vonder Haar, Labadie, MO (US)

Correspondence Address: Thomas A. Vonder Haar, 1477 Highway T, Labadie, MO, 63055, US

(21) Appl. No.: 09/966,226

(22) Filed: Sep. 28, 2001

(51) Int. Cl. G06F 17/60

(52) U.S. Cl. 705/14; 705/17

(57) ABSTRACT

The Bar and Restaurant Services Virtual Private Network is a subscription service to a group of two or more bars and restaurants connected to a centrally-operated Virtual Private Network, (VPN), using the Internet Protocol, (IP), to provide a variety of services to subscribing bar and/or restaurant owners. The services include national, regional and local advertising, electronic ordering of beverages, food and other items and services by the customer. The subscribing owner benefits from inventory and cost accounting efficiencies, as well as improved utilization of personnel.

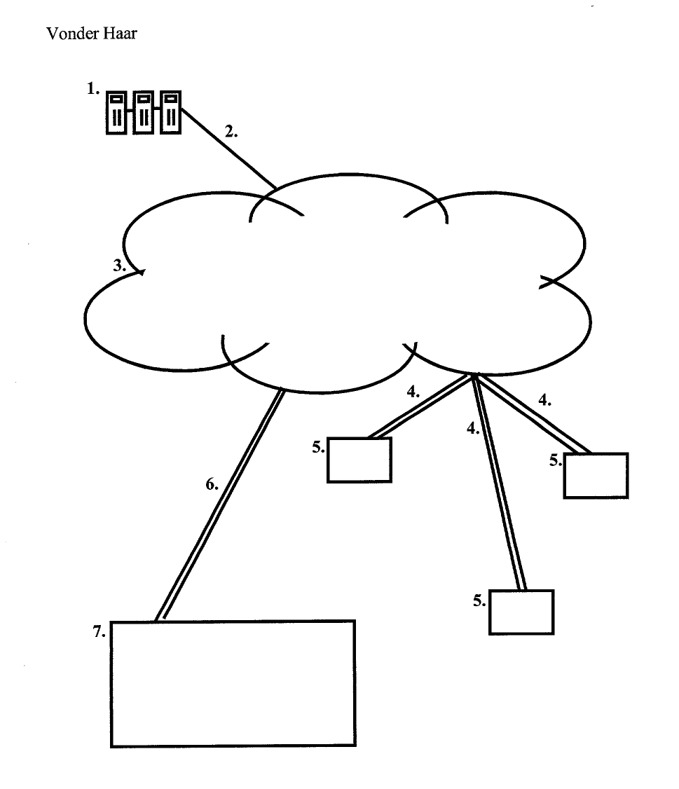

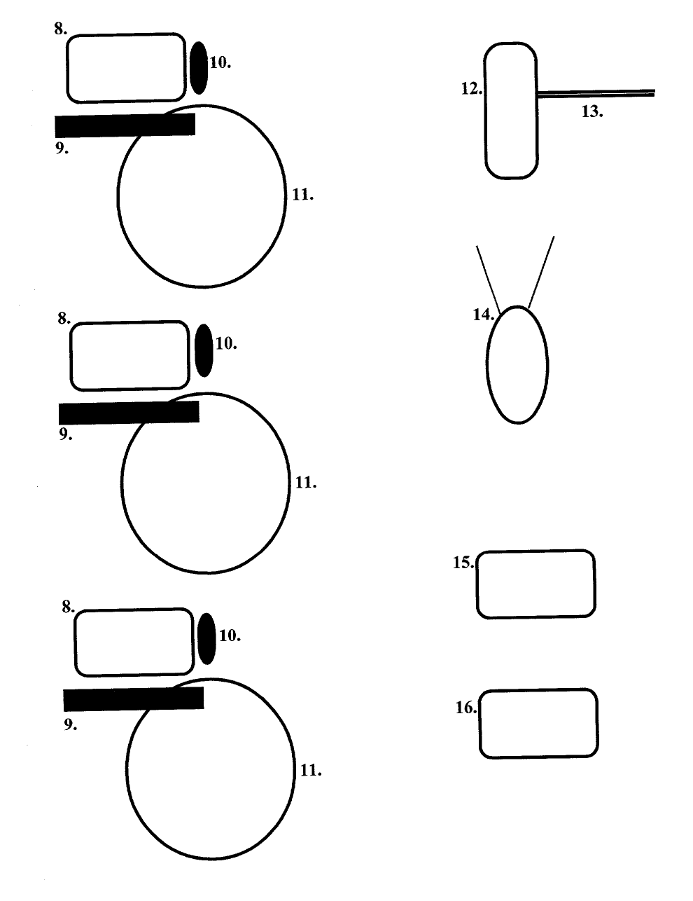

### CROSS-REFERENCE TO RELATED APPLICATIONS

Mueller, et al., U.S. Pat. No. 5,235,509

All claims of this patent relate to the touch screen ordering of food and beverages, “particularly in a fast food environment.” No claims refer to adult beverages in a bar or restaurant setting, and there are no claims that it contains advertising, or that the invention is an advertising medium, or that the invention involves connection to a national Internet Protocol Virtual Private Network.

Kurland, et al., U.S. Pat. No. 4,553,222

This patent provides for the ordering of food by means of a touch screen computing system. It also provides for entertainment at site of the patron's table. There are no claims relative to the delivery of beverages. Data storage is local, and there is mention in any claims regarding advertising. There are no claims regarding the connection to an Internet Protocol Virtual Private Network.

McHale, U.S. Pat. No. 5,913,454

All claims of this patent relate to the actual delivery of beverages to the patron by means of a plurality of tubes, nozzles and switches. In the present application, BRSVPN, beverages and food are delivered to the patron's table by a human server. There are no claims that the invention is an advertising medium or an Internet Protocol Virtual Private Network.

### STATEMENT REGARDING FEDERALLY SPONSORED RESEARCH OR DEVELOPMENT

N/A

### REFERENCE TO A MICROFICHE APPENDIX

N/A

### BACKGROUND OF THE INVENTION

Conventional broadcast advertising is inherently inefficient because, by definition, it reaches a substantial number of people who are not in the market for the particular product or service, thus much of the cost of reaching those who are in the market for the particular product or service is wasted. The BRSVPN will allow advertisers to focus tightly on selected demographic niches, in many cases at Point of Purchase. A timely ad campaign targeted to a specific audience, according to virtually all advertising literature, is likely to yield much better results.

Because of social mores and legal restrictions on advertising of such items as beers, liquors, wines and cigarettes, the BRSVP will be an outlet directed and restricted to adult customers in bars and restaurants.

In addition, bar and restaurant owners also cope with inherent inefficiencies. They often must deal with low-skilled employees who are slow and inaccurate in taking and serving beverage and food orders.

According to one industry research firm, thirty-five percent of restaurants fail because of employee theft. Annual losses from theft are nearly $20 billion. Many orders contain mistakes due to efforts to conduct several orders manually at the same time. Some restaurant chains have had to reduce the number of hours of operation because of the lack of availability of suitable employees. The inherent inefficiencies of bar and restaurant ownership have severely restricted the profit margins of even the surviving establishments.

The BRSVPN provides subscribing owners the tools with which to improve monitoring and controlling of inventory and money. It yields regular reports on consumption and sales. It increases customer satisfaction by reason of faster and more accurate service. It offers the possibility of improvement in profits. The National Restaurant Association says that success in the new millenium for bars and restaurants will “require operational excellence . . . Ever increasing competition coupled with demanding customers will drive the industry to explore more technological solutions and service-oriented practices.”

The BRSVPN is the invention that improves service with technological solutions.

### BRIEF SUMMARY OF THE INVENTION

The Bar and Restaurant Services Virtual Private Network is a subscription service to a group of two or more bars and restaurants connected to a centrally-operated Virtual Private Network, (VPN), using the Internet Protocol, (IP), to provide a variety of services to subscribing bar and/or restaurant owners. The services include national, regional and local advertising, electronic ordering of beverages, food and other items and services by the customer. The subscribing owner benefits from inventory and cost accounting efficiencies, as well as improved assignment of personnel.

### BRIEF DESCRIPTION OF THE SEVERAL VIEWS OF THE DRAWING

1. Server farm at the core of the Virtual Private Network.

2. Connection from the core to Internet can use any available and affordable technology.

3. Internet

4. Connections from the subscribers' Wireless Local Area Networks (WLANs) to the Internet. Any effective, available and affordable technology can be used.

5. The subscribing bar and/or restaurant owners Wireless Local Area Networks.

6. Corporate connection between Internet and sub-Virtual Private Network.

7. Sub-Virtual Private Network for Bar/Restaurant chains or designated marketing areas.

8. Touch screen containing menus and advertising.

9. Central processing unit.

10. Swipe for credit cards, debit cards and smart cards.

11. Tables around which customers are assembled.

12. Server of WLAN.

13. Connection of the WLAN to the Internet.

14. Wireless Access Point

15. Bar monitor.

16. Kitchen monitor.

### DETAILED DESCRIPTION OF THE INVENTION

The Bar and Restaurant Services Virtual Private Network is a subscription service to a group of two or more bars and restaurants connected to a centrally-operated Virtual Private Network, (VPN), using the Internet Protocol, (IP), to provide a variety of services to subscribing bar and/or restaurant owners. The services include national, regional and local advertising, electronic ordering of beverages, food and other items and services by the customer. The subscribing owner benefits from inventory and cost accounting efficiencies, as well as improved utilization of personnel.

Within the main network, sub-VPNs may be established to accommodate restaurant chains or geographical areas. A server farm will be the core of the national network. All content—text and graphics—will be installed at the core. For purposes of security, content control and quality control, most input to the network will be controlled at the core. The network will use the Internet Protocol, and thus will be an Internet system. At the edge of the network will be tables containing the computer with touch screen with a central processing unit, which is part of the local Wireless Local Area Network, (WLAN). Each WLAN will have a server, wireless access points, and monitors for the bar and kitchen. Limited input by means of a credit card, debit card or smart card can be made at the patron's table, and limited input can be entered by the manager of a local establishment for data retrieval purposes.

The edge of the network will be the customer table or booth at the subscribing establishment. A touch screen and a central processing unit at each table will be set up for the purposes of electronically ordering beverages from the bar, food from the kitchen, advertised merchandise or events tickets. The electronic interactive streaming-media multi-page menu will feature national advertisements, regional beverage brands and logos used as ordering buttons, local ads, stock quotes, sports news, and video games.

I claim:

1. To establish the Bar and Restaurant Virtual Private Network, (BRSVPN), a national Internet-Protocol Virtual Private Network (VPN) that provides a variety of ordering services, communications services inventory services and accounting services to subscribing bars and restaurants.

2. That the core of the BRSVPN will be a central located server farm, the only editing-input point to the network.

3. That the edge of the BRSVPN will be the customer's swipe of a credit card, debit card or smart card.

4. That the edge of the BRSVPN will constitute a computer process unit with touch screen located at the customer's table or booth.

5. That the BRSVPN will function as an advertising medium of national, regional, branding, and local advertising directed to beverage and food consumers in bars and restaurants at the Point of Purchase.

6. That the BRSVPN allows bar and restaurant customers to purchase additional merchandise, services and events tickets at the bar or restaurant table.

7. That the BRSVPN allows bar and restaurant customers to check stock prices and sports news at the table.

8. That the BRSVPN allows bar and restaurant customers to find products and services in a local ad directory.

9. That the BRSVPN contains an electronic ordering system comprising a wireless Local Area Network (WLAN) that includes computer processors and touch screens at each table, connected to wireless access points and local server.

10. That the local server will be connected to the BRSVPM by means of the Internet.

11. That the BRSVPN will provide inventory

12. sales data and

13. accounting information for subscribing bar and restaurant owners.

14. The BRSVPN will provide pay-per-view media by means of the Internet Protocol.
